(19) United States
(12) Patent Application Publication
(10) Pub. No.: US 2008/0108726 A1
(43) Pub. Date: May 8, 2008

(54) POLYCARBOXYLIC ACID RESINS, THEIR COMPOSITIONS, AND THEIR CURED PRODUCTS

(75) Inventors: Shu Guo, Gunma (JP); Takuya Kikawa, Gunma (JP); Mitsuhiro Yada, Saitama (JP); Yoshikazu Hosoda, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: SHOWA HIGHPOLYMER CO., LTD

(21) Appl. No.: 11/876,016

(22) Filed: Oct. 22, 2007

Related U.S. Application Data
(62) Division of application No. 10/522,979, filed on Feb. 2, 2005.

(30) Foreign Application Priority Data
Aug. 5, 2002 (JP) 2002-227511

(51) Int. Cl. C08G 63/42; C08G 65/00

(52) U.S. Cl. 522/170; 528/297

(57) ABSTRACT

To provide a polycarboxylic acid resin which is obtained by reacting an epoxy resin (a) having two glycidyl groups with, e.g. itaconic acid (b) and ethylenic monocarboxylic acid (c) to obtain linear adduct polymer (A); and by reacting linear adduct polymer (A) with polybasic acid anhydride (d). According to the present invention, there are provided a polycarboxylic acid resin, its composition, and its cured product. The composition can facilely be dried upon preliminary heating and show an improved tack-free property, an excellent photo-curing property, an excellent development property in an aqueous alkali solution, and excellent physical properties such as electrical, mechanical, heat resistance, solvent resistance, adhesiveness, flexibility, etc.

This is a divisional of application Ser. No. 10/522,979 filed Feb. 2, 2005. The entire disclosure(s) of the prior application(s), application Ser. No. 10/522,979 is considered part of the disclosure of the accompanying divisional application and is hereby incorporated by reference.

### TECHNICAL FIELD

The present invention relates to a polycarboxylic acid resin, its composition, and its cured product. These materials can be used as photosensitive resin materials suitable for solder resists for print circuit boards, electroless plating resists, insulative layers of print circuit boards by build-up methods, black matrices, colour filters, etc. in production of printing plates and liquid crystal display panels.

### BACKGROUND ART

In recent years, a number of photo-curing type resin compositions have been used in various fields for reasons of resource saving, energy saving, improvement in workability, and improvement in productivity. In addition, higher definition productions, etc. have rapidly been developed for print circuit boards and flat panel displays in accordance with a higher density of ICs and LSIs. In this field, a higher resolution and a higher dimensional stability of photosensitive resin materials have also been desired.

Development of photosensitive resins involves environmental problems. Hence, development with a dilute alkaline solution becomes major instead of development with an organic solvent. Examples of alkaline development type resists include carboxyl group-containing epoxy(meth)acrylates, into the ends of which a polymerisable unsaturated group has been introduced and a carboxyl group has also been introduced by reaction with an acid anhydride, for example, as described in JP7-50473A and JP7-17737B. However, because of smaller molecular weights of the polycarboxylic acid resins, they are not good at being dried in a pre-heat drying step in cases of as fluid resists. In addition, since such polycarboxylic acid resins have disadvantages of tacking or adhesive properties, they are not suitable for contact exposure.

JP6-180501A shows an attempt to improve drying characteristics of guanamine-based resins upon precuring. Although the drying characteristics can be improved, toughness of the resulting resist films after post-curing is inferior and thus is insufficient tracking property on a substrate with a problem of intolerance against electroless deposition, etc.

Furthermore, JP2000-53746A proposes a method of manufacturing a photosensitive resin that satisfies both an increasing molecular weight and an alkali development property by a reaction between a compound keeping epoxy groups, after a reaction of an unsaturated monocarboxylic acid of 0.5-0.9 chemical equivalents per one chemical equivalent of the epoxy groups, and a polybasic acid anhydride. In this technology, however, the number of photosensitive groups capable of being introduced per molecule is limited, causing a disadvantage of a low photo-sensitivity.

Furthermore, JP2002-121258A discloses a resin for resists prepared by reacting an epoxy acrylate compound containing a hydroxyl group with an acid anhydride, the epoxy acrylate compound being obtained by reaction of a secondary hydroxyl group with a dibasic acid anhydride successively in a ring-opening manner, and the secondary hydroxyl group generated by a reaction between an epoxy resin and an unsaturated monocarboxylic acid. In this technology, however, in the reaction amongst the epoxy resin, the unsaturated monocarboxylic acid and the dibasic acid anhydride, the hydroxyl group firstly is generated by the reaction between the epoxy resin and the unsaturated monocarboxylic acid, the hydroxyl group of the epoxy resin itself secondly is subjected to a ring-opening addition reaction with the dibasic acid anhydride, and then one of the carboxylic groups generated by the ring-opening addition reaction reacts with a remaining epoxy group. Since the epoxy and hydroxyl groups of the epoxy resin react with the dibasic acid anhydride to provide the epoxy resin with 4 or more functional reactive groups, the resulting compound has many branching structures in its molecule and thus the molecular weight of the epoxy resin can be hardly controlled in the reaction. In particular, it is difficult to increase the molecular weight of the resulting compound to obtain a tack-free dried coating film. Even if a high molecular-weight resulting compound could be obtained, there would be a problem that no sufficient flexibility, no heat stability, etc. could be obtained because of such branching structures.

Moreover, JP2002-173518A discloses a technology directing to compensate for reduction in the number of photosensitive groups per molecular weight in response to an increase in molecular weight of a vinyl ester by reaction of a partially esterified dibasic acid with a divalent epoxy resin, the partially esterified dibasic acid being obtained by a previous reaction of a polybasic acid anhydride with a (meth)acryloyl compound having a hydroxyl group. However, this technology results in introduction of a polybasic acid anhydride residue of a relatively large molecular weight into the polymer structure because of introduction of photosensitive groups. The proportion of hydroxyl groups in the main chain of the polymer decreases to lower the development property in an aqueous alkali solution accordingly. In addition, there is a problem that the water resistance of a cured coating film is decreased because of an increased content of ester groups in resin compositions.

Furthermore, there are a dry film method, a fluid development type resist method, etc. as methods for patterning resin compositions for resists, such as solder resists for manufacturing print circuit boards, electroless plating resists, insulative layers of build-up method print circuit boards or printing plates, black matrices, colour filters, etc. for production of liquid crystal display panels. Of these methods, the fluid development type resist method is suitable for patterning finely wired substrates, etc. This method involves applying a resin composition for resists onto a target to be patterned; thermally drying the composition on the target to form a coating film on the target; and bringing the coating film into a press contact with a film for patterning for exposure development. In this process, if any tacking or adhesive property remains in the coating film after the above thermal drying, part of the resist may be attached to the patterned film upon peeling off, resulting in a pattern film without reproducibility and/or without capability of being peeled off. Therefore, tack-free property after formation of coating films is one of important properties to be requested in fluid development type resists. In addition, alkali development property after exposure also is one of important properties. Therefore, to form fine coating films with a higher reliability and a good development property, an un-exposed pattern of the coating film should quickly be removed upon development. However, both alkali development and tack-free properties, which are opposed to each other, can hardly be satisfied at the same time because tack-free property tends to become lower if improvement of development property is attempted.

### DISCLOSURE OF THE INVENTION

Therefore, an object of the present invention is to provide a polycarboxylic acid resin, its composition, and its cured product. The composition can facilely be dried upon preliminary heating, the cured product shows an improved tack-free property, an excellent development property in an aqueous alkali solution, and an excellent physical properties such as electrical, mechanical, heat resistance, solvent resistance, adhesiveness, flexibility, etc.

According to one aspect of the present invention, there is provided a polycarboxylic acid resin obtained by reacting one or more epoxy resin(s) (a), having two glycidyl groups, with one or more dibasic acid(s) (b), represented by the general formula (1) shown below having 4-10 carbon atoms, and one or more ethylenically unsaturated monocarboxylic acid(s) (c) to obtain a linear adduct polymer (A); and by reacting the linear addition polymer (A) with one or more polybasic acid anhydride(s) (d).

(wherein R₂′ represents an alkylene, hydroxyalkylene, alkenylene, cycloalkylene, or cycloalkenylene group having 2-8 carbon atoms)

In another aspect of the present invention, the polycarboxylic acid resin is characterized in that it is represented by the general formula (2) shown below:

(wherein R₁′ represents a divalent group derived from epoxy resin (a) having two glycidyl groups, R₂′ represents an alkylene, hydroxyalkylene, alkenylene, cycloalkylene, or cycloalkenylene group having 2-8 carbon atoms, R₃′ represents a hydrogen atom or the general formula (3) shown below, and m represents an integer of 0 or 1 to 20.

(wherein R₄′ represents an organic group having 2-8 carbon atoms derived from polybasic acid anhydride (d))

In another aspect of the present invention, epoxy resin (a) having two glycidyl groups is an epoxy resin represented by the general formula (4) shown below:

(wherein R¹, R², R³, and R⁴ independently represent a hydrogen atom or a methyl group, Y represents a glycidyl group, and n represents an integer of 0 or 1 to 10).

In another aspect of the present invention, ethylenically unsaturated monocarboxylic acid (c) is an acrylic acid and/or a methacrylic acid.

In another aspect of the present invention, dibasic acid (b) contains itaconic acid as an essential ingredient.

According to another aspect of the present invention, there is provided a polycarboxylic acid resin composition containing any one of the above polycarboxylic acid resins, a reactive diluent (g), and a sealant (h).

In another aspect of the present invention, the composition further contains a photopolymerisation initiator (i).

According to another aspect of the present invention, there is provided a cured product prepared by curing any one of the above polycarboxylic acid resin compositions.

Hereinafter, the present invention will be described in more detail.

Polycarboxylic acid resins of the present invention can be obtained by reacting one or more epoxy resin (a) having two glycidyl groups with one or more dibasic acid (b) represented by the above general formula (1) having 4-10 carbon atoms and one or more ethylenically unsaturated monocarboxylic acid (c) to obtain linear adduct polymer (A); and by then reacting linear addition polymer (A) with one or more polybasic acid anhydride (d).

Epoxy resin (a) having two glycidyl groups which can be used in the present invention is not particularly limited as far as epoxy resin (a) contains two glycidyl groups in its molecule. Concrete examples of epoxy resin (a) having two glycidyl groups include, but are not limited to, glycidyl ethers such as bisphenol epoxy resins obtained by reacting bisphenols (e.g. bisphenol A, bisphenol F, bisphenol S, tetrabromobisphenol A, and bisphenol fluorene) with epichlorohydrin and/or methyl epichlorohydrin, obtained by reacting condensation products between glycidyl ether of bisphenol A and the above phenols with epichlorohydrin and/or methyl epichlorohydrin, obtained by reacting bisphenol with epichlorohydrin and/or methyl epichlorohydrin (e.g. Epicoat YX-4000, manufactured by Japan Epoxy Resins, Co., Ltd.), obtained by reacting dihydroxynaphthalene with epichlorohydrin and/or methyl epichlorohydrin (e.g. EPICLON HP-4032, manufactured by Dainippon Ink & Chemicals, Inc.), and obtained by reacting alkyldiphenol with epichlorohydrin and/or methyl epichlorohydrin (e.g. EPICLON EXA-7120, manufactured by Dainippon Ink & Chemicals, Inc.); glycidyl esters such as dimer acid diglycidyl ester and hexahydrophthalic acid diglycidyl ester; glycidyl amines such as diglycidyl aniline and diglycidyl toluidine; alicyclic types such as alicyclic diepoxyacetal, alicyclic diepoxyadipate, and alicyclic diepoxycarboxylate; and oxazolidones obtained by reacting the above epoxy resins with diisocyanate (e.g. Araldite AER4152, manufactured by Asahi Kasei Epoxy Co., Ltd.). In addition, epoxy resin (a) having two glycidyl groups may be one type of the above epoxy resins or a mixture of two or more types of the above epoxy resins. In particular, epoxy resin (a) having two glycidyl groups is preferably one having a structure represented by the following general formula (4):

(wherein R¹, R², R³, and R⁴ independently represent a hydrogen atom or a methyl group, Y represents a glycidyl group, and n represents an integer of 0 or 1 to 10), which is an epoxy resin excellent in heat resistance and chemical resistance, has two glycidyl groups, and can be reacted such that the molecular weight should linearly increase without gelatinisation.

Dibasic acid (b) used in the present invention is preferably represented by the above general formula (1) having 4-10 carbon atoms (wherein R₂′ represents an alkylene, hydroxyalkylene, alkenylene, cycloalkylene, or cycloalkenylene group having 2-8 carbon atoms). Such a carbon number and such a saturated or unsaturated linear or cyclic structure lead to an increased proportion of hydroxyl groups generated by reactions between glycidyl groups of epoxy resins (a) having two glycidyl groups and dibasic acid (b) in the repetitive units of the macromolecule linear adduct polymer (A), allowing exhibition of prompt alkali solubility.

Therefore, when dibasic acid (b) has 11 or more carbon atoms, a polycarboxylic acid resin having sufficient alkali solubility intended by the present invention cannot be obtained. On the other hand, when dibasic acid (b) has 10 or less carbon atoms, the proportion of the hydroxyl groups in linear adduct polymer (A) provides a sufficient solubility in alkali. The number of carbon atoms is preferably 8 or less, more preferably 6 or less. Examples of dibasic acid (b) include succinic acid, fumaric acid, maleic acid, glutaric acid, itaconic acid, adipic acid, tetrahydrophthalic acid, hexahydrophthalic acid, and ethylene glycol/2-mol maleic anhydride adduct. In particular, when itaconic acid is used, there is introduced an ethylenically unsaturated bond. Thus, itaconic acid is preferable because the curability of polycarboxylic acid resins of the present invention is improved to provide a good cured product.

Furthermore, dibasic acid (b) that reacts with epoxy resin (a) having two glycidyl groups may be a dibasic carboxylic acid having a hydroxyl group because it is useful for the purpose of increasing the development property of polycarboxylic acid resins of the present invention as well as their adhesiveness to a substrate by multiplying the number of hydroxyl groups of linear adduct polymer (A) more than the number of hydroxyl groups generated by the reaction between the glycidyl groups and the carboxyl groups. Dibasic carboxylic acids having hydroxyl groups include malic acid, tartaric acid, and mucic acid. One or a plurality of dibasic acid (b) may be used.

Ethylenically unsaturated monocarboxylic acid (c) used in the present invention plays a role of introducing an ethylenically unsaturated group as a photosensitive group into the ends of polycarboxylic acid resins of the present invention as well as a role of controlling the molecular weight of linear adduct polymer (A). Examples of ethylenically unsaturated monocarboxylic acid (c) include (meth)acrylic acid, crotonic acid, and cinnamic acid. In addition, for example, a reaction product obtained by reacting polyfunctional (meth)acrylate having one hydroxyl group and two or more (meth)acroyl groups with a polybasic acid anhydride may be used. However, preferable is (meth)acrylic acid.

The proportion between dibasic acid (b) and ethylenically unsaturated monocarboxylic acid (c) for production of linear adduct polymer (A) is preferably from 1:20 to 5:1 (the former:the latter), more preferably from 1:5 to 1:1 in molar ratios. If the proportion of ethylenically unsaturated monocarboxylic acid (c) is less than 5:1, the molecular weight of the polycarboxylic acid resin of the present invention increases too much and becomes unsuitable for a photosensitive resin material. If the proportion is greater than 1:20, the effect by a sufficient increase in the molecular weight cannot be obtained.

Furthermore, for production of linear adduct polymer (A), the proportion amongst epoxy resin (a) having two glycidyl groups, dibasic acid (b), and ethylenically unsaturated monocarboxylic acid (c) is such that the sum of dibasic acid (b) and ethylenically unsaturated monocarboxylic acid (c) is preferably an equivalent weight of 0.9-1.1, more preferably an equivalent weight of 0.95-1.05 per the equivalent weight of the epoxy groups of epoxy resin (a) having two glycidyl groups. If the equivalent weight of the carboxyl groups is less than 0.9, linear adduct polymer (A) tends to be gelatinised when it reacts with polybasic acid anhydride (d). In contrast, if the equivalent weight exceeds 1.1, the amount of unreacted acids increases too much and thus stability after blending with ink tends to decrease.

Examples of polybasic acid anhydride (d) include maleic anhydride, succinic anhydride, itaconic anhydride, phthalic anhydride, tetrahydrophthalic anhydride, hexahydrophthalic anhydride, methylhexahydrophthalic anhydride, endomethylene tetrahydrophthalic anhydride, trimellitic anhydride, pyromellitic anhydride, and benzophenone tetracarboxylic dianhydride, which may be used individually or in combination. The addition amount of polybasic acid anhydride (d) is preferably 20-120 KOHmg/g, more preferably 40-100 KOHmg/g in the acid value of the polycarboxylic acid resin.

The molecular weights of linear adduct polymer (A) range from 800 to 12,000, preferably from 1,200 to 8,000 in terms of number average molecular weights of polystyrene. If the molecular weights of linear addition polymer (A) are less than 800, a tack-free coating film cannot be obtained after drying with heating. A molecular weight of linear adduct polymer (A) exceeding 12,000 is not preferable because a trouble in coating occurs.

In the above general formula (2) of the polycarboxylic acid resins, m is preferably 0 or 1-20, more preferably 0 or 1-10.

A method of synthesising the polycarboxylic acid resins in accordance with the present invention includes, just as in cases of synthesising a normal polycarboxylic acid resin, reacting epoxy resin (a) having two glycidyl groups with respective predetermined amounts of dibasic acid (b) and ethylenically unsaturated monocarboxylic acid (c) using an esterification catalyst; and reacting the primary or secondary hydroxyl groups of the resulting linear adduct polymer (A) with polybasic acid anhydrides (d) using a catalyst to conduct ring-opening additions to synthesise the polycarboxylic acid resin of the present invention. However, synthesis methods are not limited to particular ones.

The completion of the reaction amongst epoxy resin (a) having two glycidyl groups, dibasic acid (b), and ethylenically unsaturated monocarboxylic acid (c) can be observed by reduction of the acid value or disappearance of the epoxy absorbance peak at 910 cm⁻¹ in infrared (IR) spectroscopy. For example, FIG. 1 is a chart that shows an infrared absorption spectrum of the bisphenol A type epoxy resin used in Example 1. FIG. 2 is a chart that shows an infrared absorption spectrum of the reaction product (the linear adduct polymer) obtained in Example 1. Disappearance at 910 cm⁻¹ can be observed by comparison between both the charts.

Furthermore, the completion of the reaction between the primary or secondary hydroxyl groups of the resulting linear adduct polymer (A) and polybasic acid anhydride (d) can be observed by the disappearances of the absorption peaks of the acid anhydride at 1,770 cm⁻¹ and 1,850 cm⁻¹ in IR spectroscopy. For instance, FIG. 3 shows a chart of an infrared absorption spectrum of tetrahydrophthalic anhydride used in Example 1. FIG. 4 shows a chart of an infrared absorption spectrum of polycarboxylic acid resin (A-1) obtained in Example 1. The disappearances at 1,770 cm⁻¹ and 1,850 cm⁻¹ can be observed by comparison between both the charts.

According to another aspect of the present invention, there is provided a polycarboxylic acid resin composition containing the above polycarboxylic acid resin, a reactive diluent (g), and a sealant (h). Furthermore, the polycarboxylic acid resin composition may contain photopolymerisation initiator (i) and provide a photo-curing type polycarboxylic acid resin composition. Furthermore, the present invention provides a cured product prepared by curing the above polycarboxylic acid resin composition and the above photo-curing type polycarboxylic acid resin composition.

To a polycarboxylic acid resin composition of the present invention, reactive diluent (g) can be added. Examples of available reactive diluents (g) include: aromatic vinyl monomers such as styrene, α-methylstyrene, α-chloromethylstyrene, vinyltoluene, divinylbenzene, diallylphthalate, and diallylbenzenephosphonate; polycarboxylic acid monomers such as vinyl acetate and vinyl adipate; (meth)acrylic monomers such as methyl (meth)acrylate, ethyl (meth)acrylate, propyl (meth)acrylate, butyl (meth)acrylate, β-hydroxyethyl (meth)acrylate, hydroxypropyl (meth)acrylate, (di)ethylene glycol (meth)acrylate, propylene glycol (di)ethylene glycol (meth)acrylate, trimethylolpropane di(meth)acrylate, trimethylolpropane tri(meth)acrylate, pentaerythritol tetra(meth)acrylate, pentaerythritol hexa(meth)acrylate, and tri(meth)acrylate of tris(hydroxyethyl)isocyanurate; and triallylcyanurate. One or two or more kind(s) of such monomers can be used.

Reactive diluent (g) is blended preferably in a blending amount of 5-100 parts by weight with respect to 100 parts by weight of a solid content of the polycarboxylic acid resin of the present invention.

Polycarboxylic acid resin compositions of the present invention may be post-cured. Accordingly, sealant (h) may be used. Examples of sealant (h) include epoxy resins such as novolac epoxy resins, bisphenol epoxy resins, bisphenol-F epoxy resins, alicyclic epoxy resins, and triglycidyl isocyanurate. Furthermore, sealant (h) may be used together with an epoxy curing agent such as dicyandiamide or an imidazole compound.

Sealant (h) is blended in an epoxy equivalent weight of 0.5-2.0, preferably 1.0-1.5, per the equivalent weight of the carboxyl groups of a polycarboxylic acid resin of the present invention.

To a polycarboxylic acid resin composition of the present invention can be added photopolymerisation initiator (i) in order to photo-cure the composition with UV irradiation, etc. Examples of available photopolymerisation initiators (i) include: benzoin and alkyl ethers thereof such as benzoin, benzoin methyl ether, and benzoin ethyl ether; acetophenones such as acetophenone, 2,2-dimethoxy-2-phenylacetophenone, 1,1-dichloroacetophenone, and 4-(1-t-butyldioxy-1-methylethyl)acetophenone; anthraquinones such as 2-methylanthraquinone, 2-amylanthraquinone, 2-t-butylanthraquinone, and 1-chloroanthraquinone; thioxanthones such as 2,4-dimethylthioxanthone, 2,4-diisopropylthioxanthone, and 2-chlorothioxanthone; ketals such as acetophenone dimethyl ketal and benzyl dimethyl ketal; benzophenones such as benzophenone, 4-(1-t-butyldioxy-1-methylethyl)benzophenone, and 3,3′,4,4′-tetrakis(t-butyldioxycarbonyl)benzophenone; 2-methyl-1-[4-(methylthio)phenyl]-2-morpholino-propan-1-one and 2-benzyl-2-dimethylamino-1-(4-morpholinophenyl)butan-1-one; acylphosphineoxides; and xanthones.

Photopolymerisation initiator (i) is blended preferably in an amount of 0.5-30 parts by weight with respect to 100 parts by weight of the solid content of a polycarboxylic acid resin of the present invention.

Furthermore, if required, compositions of the present invention may contain fillers such as talc, clay, and barium sulphate, colouring pigments, antifoaming agents, coupling agents, and leveling agents.

In addition, compositions of the present invention are used not only as photosensitive resist materials to be applied to print circuit boards but also as a wide variety of printing plates, liquid crystal display materials, and photosensitive materials for plasma displays. Such compositions of the present invention have a high exposure sensitivity, and a good development property with an aqueous alkaline solution. Further, such compositions of the present invention are photosensitive resin materials which can form cured coating films excellent in electrical characteristics, mechanical characteristics, heat resistance, chemical resistance, etc. by curing after development.

### BRIEF DESCRIPTION OF THE DRAWINGS

FIG. 1 is a chart that shows an infrared (IR) absorption spectrum of a bisphenol-A epoxy resin used in Example 1.

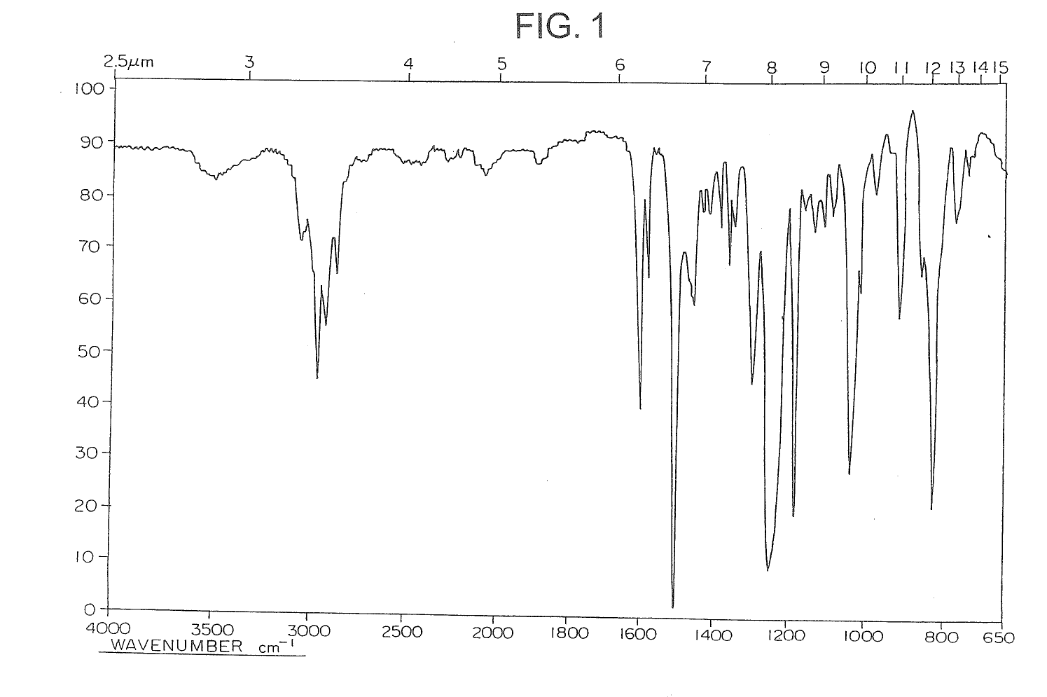

FIG. 2 is a chart that shows an IR absorption spectrum of a reaction product (a linear adduct polymer) obtained in Example 1.

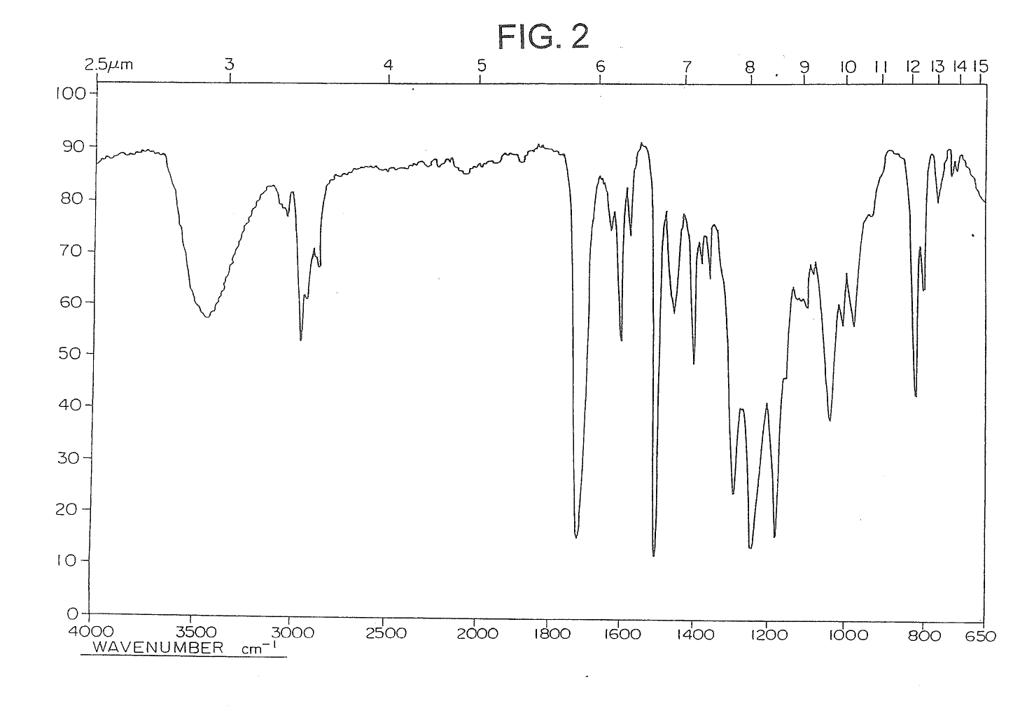

FIG. 3 is a chart that shows an IR absorption spectrum of tetrahydrophthalic anhydride used in Example 1.

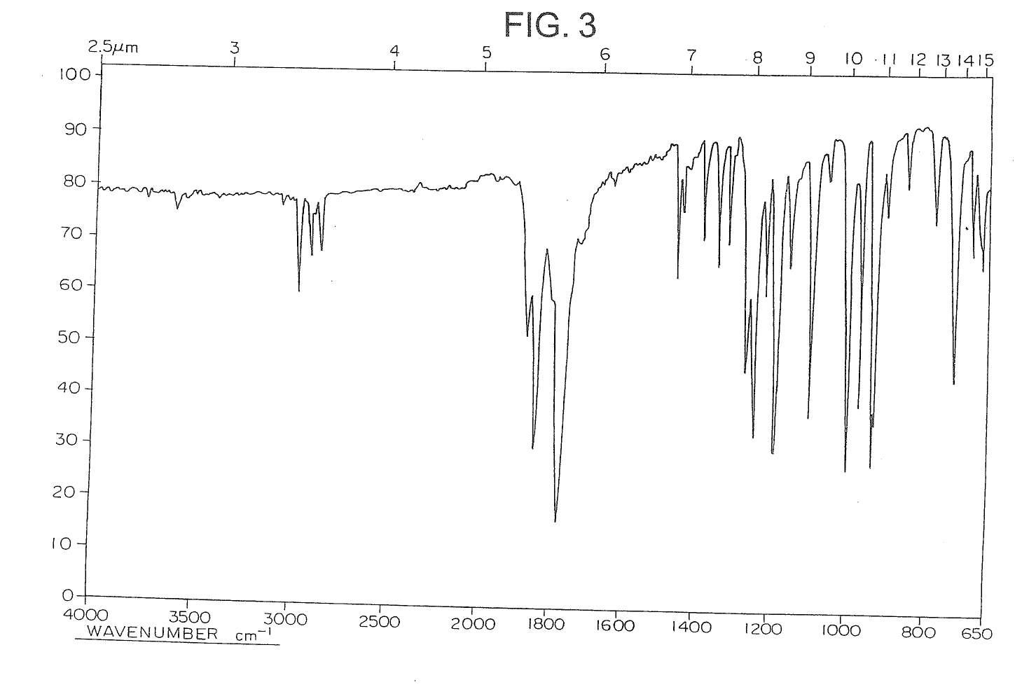

FIG. 4 is a chart that shows an IR absorption spectrum of a polycarboxylic acid resin (A-1) obtained in Example 1.

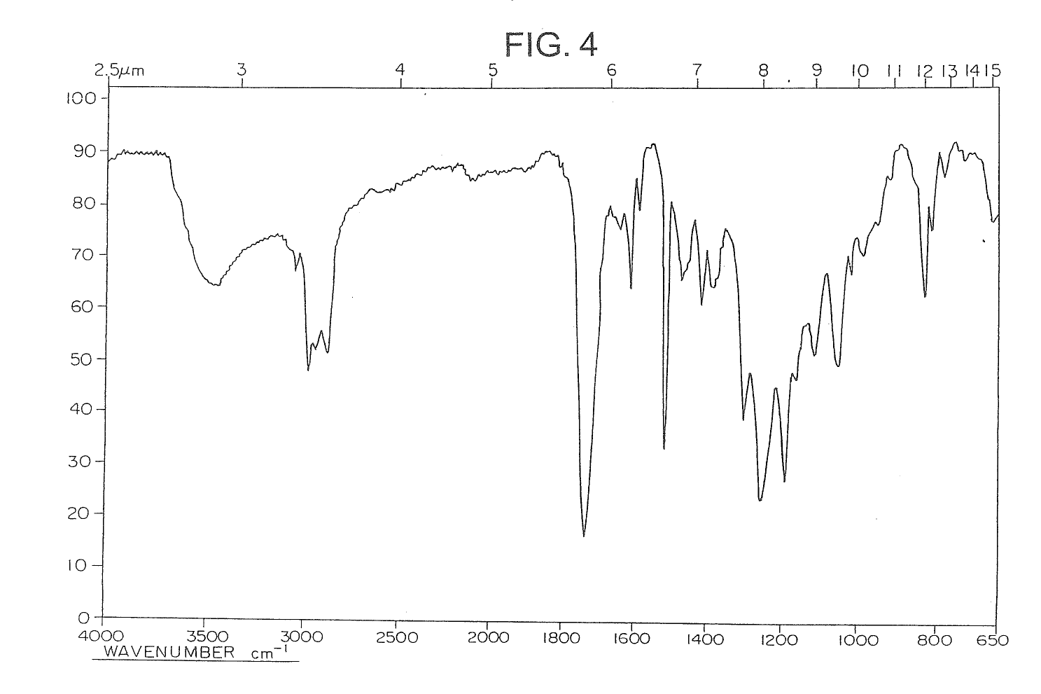

### BEST MODE FOR CARRYING OUT THE INVENTION

Hereinafter, the present invention will be described in more detail with reference to examples and comparative examples. Unless otherwise specified, all of “parts” and “%” are weight basis.

### Synthesis Example 1

In a four-neck flask with a stirrer, a thermometer, an air-trapping tube, and a reflux condenser, 186 parts of a bisphenol-A epoxy resin (Araldite AER2603, manufactured by Asahi Kasei Epoxy Co., Ltd., with an epoxy equivalent weight of 186), 32.5 parts of itaconic acid, 36 parts of acrylic acid, 220 parts of ethyl carbitol acetate, 0.8 parts of triphenylphosphine, and 0.2 parts of methyl hydroquinone were charged and then heated at 120° C. while air was blown into the flask for about 20 hours, resulting in a reaction product having an acid value of 0.5 KOH mg/g. The reaction product had a number average molecular weight of 4,000 in terms of polystyrene.

Subsequently, 76 parts of tetrahydrophthalic anhydride were added and then the resulting mixture was reacted for further 6 hours at 100° C., resulting in a photosensitive polycarboxylic acid resin (A-1) having a solid content acid value of 84.8 KOH mg/g and a solid content concentration of 60.0%.

### Synthesis Example 2

Similarly to Synthesis Example 1, 190 parts of a bisphenol-A epoxy resin (Epothto YD-128, manufactured by Tohto Kasei Co., Ltd., with an epoxy equivalent of 190), 39.0 parts of itaconic acid, 34.4 parts of methacrylic acid, 236 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.8 KOH mg/g. The reaction product had a number average molecular weight of 4,800 in terms of polystyrene.

Subsequently, 91.3 parts of tetrahydrophthalic anhydride were added and then the resulting mixture was reacted for further 6 hours at 100° C., resulting in a photosensitive polycarboxylic acid resin (A-2) having a solid content acid value of 95.0 KOH mg/g and a solid content concentration of 60.0%.

### Synthesis Example 3

Similarly to Synthesis Example 1, 186 parts of a bisphenol-A epoxy resin (Araldite AER2603, manufactured by Asahi Kasei Epoxy Co., Ltd., with an epoxy equivalent weight of 186), 40.2 parts of malic acid, 33.4 parts of methacrylic acid, 202.9 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.6 KOH mg/g. The reaction product had a number average molecular weight of 5,600 in terms of polystyrene.

Subsequently, 44.8 parts of itaconic anhydride were added and then the resulting mixture was reacted for further 6 hours at 100° C., resulting in a photosensitive polycarboxylic acid resin (A-3) having a solid content acid value of 73.7 KOH mg/g and a solid content concentration of 60.0%.

### Synthesis Example 4

Similarly to Synthesis Example 1, 190 parts of a bisphenol-A epoxy resin (Epothto YD-128, manufactured by Tohto Kasei Co., Ltd., with an epoxy equivalent of 190), 26.8 parts of itaconic acid, 51.7 parts of methacrylic acid, 240.6 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.9 KOH mg/g. The reaction product had a number average molecular weight of 2,800 in terms of polystyrene.

Subsequently, 92.5 parts of hexahydrophthalic anhydride were added and then the resulting mixture was reacted for further 6 hours at 100° C., resulting in a photosensitive polycarboxylic acid resin (A-4) having a solid content acid value of 93.2 KOH mg/g and a solid content concentration of 60.0%.

### Synthesis Example 5

Similarly to Synthesis Example 1, 186 parts of a bisphenol-A epoxy resin (Araldite AER2603, manufactured by Asahi Kasei Epoxy Co., Ltd., with an epoxy equivalent weight of 186), 26.0 parts of itaconic acid, 51.7 parts of methacrylic acid, 202.5 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.4 KOH mg/g. The reaction product had a number average molecular weight of 2,200 in terms of polystyrene.

Subsequently, 40 parts of succinic anhydride were added and then the resulting mixture was reacted for further 6 hours at 100° C., resulting in a photosensitive polycarboxylic acid resin (A-5) having a solid content acid value of 73.9 KOH mg/g and a solid content concentration of 60.0%.

### Synthesis Example 6

Similarly to Synthesis Example 1, 190 parts of a bisphenol-A epoxy resin (Epothto YD-128, manufactured by Tohto Kasei Co., Ltd., with an epoxy equivalent of 190), 46.9 parts of malic acid, 21.6 parts of acrylic acid, 209.7 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.7 KOH mg/g. The reaction product had a number average molecular weight of 7,200 in terms of polystyrene.

Subsequently, 56 parts of itaconic anhydride were introduced and then the resulting mixture was reacted for further 6 hours at 100° C., resulting in a photosensitive polycarboxylic acid resin (A-6) having a solid content acid value of 89.1 KOH mg/g and a solid content concentration of 60.0%.

### Synthesis Example 7

Similarly to Synthesis Example 1, 170 parts of a bisphenol-F epoxy resin (Epomic R110, manufactured by Mitsui Chemicals, Inc., with an epoxy equivalent weight of 170), 19.5 parts of itaconic acid, 50.4 parts of acrylic acid, 210.6 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.3 KOH mg/g. The reaction product had a number average molecular weight of 1,600 in terms of polystyrene.

Subsequently, 76 parts of tetrahydrophthalic anhydride were added and then the resulting mixture was reacted for further 6 hours at 100° C., resulting in a photosensitive polycarboxylic acid resin (A-7) having a solid content acid value of 88.8 KOH mg/g and a solid content concentration of 60.0%.

### Synthesis Example 8

Similarly to Synthesis Example 1, 170 parts of a bisphenol-F epoxy resin (Epomic R110, manufactured by Mitsui Chemicals, Inc., with an epoxy equivalent weight of 170), 33.5 parts of malic acid, 36 parts of acrylic acid, 211.9 parts of ethyl carbitol acetate, 0.8 parts of triphenylphosphine, and 0.2 parts of methyl hydroquinone were mixeded and then heated at 120° C. while air was blown into the mixture for about 20 hours, resulting in a reaction product having an acid value of 0.7 KOH mg/g and a number average molecular weight of 4,400 in terms of polystyrene.

Subsequently, 78.4 parts of itaconic anhydride were added and then the resulting mixture was reacted for further 6 hours at 100° C., resulting in a photosensitive polycarboxylic acid resin (A-8) having a solid content acid value of 123.5 KOH mg/g and a solid content concentration of 60.0%.

### Comparative Synthesis Example 1

Similarly to Synthesis Example 1, 190 parts of a bisphenol-A epoxy resin (Epothto YD-128, manufactured by Tohto Kasei Co., Ltd., with an epoxy equivalent of 190), 72 parts of acrylic acid, 225.3 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.8 KOH mg/g and a number average molecular weight of 320 in terms of polystyrene.

Subsequently, 76 parts of tetrahydrophthalic anhydride were added and then the resulting mixture was reacted for further 6 hours at 100° C., resulting in a photosensitive polycarboxylic acid resin (B-1) having a solid content acid value of 83.0 KOH mg/g and a solid content concentration of 60.0%.

### Comparative Synthesis Example 2

Similarly to Synthesis Example 1, 186 parts of a bisphenol-A epoxy resin (Araldite AER2603, manufactured by Asahi Kasei Epoxy Co., Ltd., with an epoxy equivalent weight of 186), 38.0 parts of tetrahydrophthalic anhydride, 54 parts of acrylic acid, 241.2 parts of ethyl carbitol acetate, 0.8 parts of triphenylphosphine, and 0.2 parts of methyl hydroquinone were mixed and then heated at 120° C. while air was blown into the mixture for about 20 hours, resulting in a reaction product having an acid value of 0.5 KOH mg/g and a number average molecular weight of 1,600 in terms of polystyrene.

Subsequently, 83.8 parts of tetrahydrophthalic anhydride were added and then the resulting mixture was reacted for further 6 hours at 100° C., resulting in a photosensitive polycarboxylic acid resin (B-2) having a solid content acid value of 85.5 KOH mg/g and a solid content concentration of 60.0%.

### Comparative Synthesis Example 3

Similarly to Synthesis Example 1, 153.6 parts of trimellitic anhydride and 92.3 parts of hydroxyethyl acrylate were mixed and then heated at 100° C. for about 5 hours, resulting in a half-ester product having an acid value of 182 KOH mg/g. Subsequently, 200 parts of ethyl carbitol acetate were added, and then 33.2 parts of isophthalic acid, 752 parts of a bisphenol-A epoxy resin (Araldite AER2603, manufactured by Asahi Kasei Epoxy Co., Ltd., with an epoxy equivalent weight of 186), and 1 part of hydroquinone were added. Subsequently, 144 parts of acrylic acid and 2 parts of triphenylphosphine were added and then the resulting mixture was heated at 120° C. while air was blown into the mixture to carry out a 12-hour esterification reaction, resulting in a reaction product having an acid value of 0.3 KOH mg/g. Subsequently, 836.4 parts of ethyl carbitol acetate and 379 parts of tetrahydrophthalic anhydride were added and then the resulting mixture was reacted for 5 hours at 100° C., resulting in a photosensitive polycarboxylic acid resin (B-3) having a solid content acid value of 90.2 KOH mg/g, a solid content concentration of 60.0%, and a number average molecular weight of 1,900 in terms of polystyrene.

### Examples 1-8 and Comparative Examples 1-3

The photosensitive polycarboxylic acid resins (from A-1 to A-8 and from B-1 to B-3) obtained in Synthesis Examples 1-8 and Comparative Synthesis Examples 1-3, respectively, were blended with the respective ingredients in the blending ratios shown below and then sufficiently mixed with 3 rolls to obtain the respective photo-curing type polycarboxylic acid resin compositions. The compositions prepared from resins A-1, A-2, A-3, A-4, A-5, A-6, A-7, A-8, B-1, B-2 and B-3 are referred to as Examples 1, 2, 3, 4, 5, 6, 7 and 8, and Comparative Examples 1, 2 and 3, respectively.

| | |
|---|---|
| Photosensitive polycarboxylic acid resin | 100 parts |
| (A-1 to A-8, B-1 to B-3) solid content | |
| Butylcellosolve | 10 parts |
| Trimethylolpropane triacrylate | 20 parts |
| 2,2-dimethoxy-2-phenylacetophenone | 5 parts |
| Barium sulphate | 57 parts |
| Powdered silica | 2 parts |
| Phthalocyanine green | 1 part |
| 1,3,5-triglycidyl isocyanurate | 10 parts |
| Dicyanediamide | 5 parts |

Subsequently, by a screen printing method, each of the compositions was applied to a print circuit board whose surface had treated so as to be of 3040 μm thickness, and then was preliminarily dried at 80° C. for 20 minutes, followed by cooling down to room temperature (RT) to obtain a dried coating film. It was subjected to a 60-second exposure process using an exposure device, having parallel ultra high-pressure mercury (Hg) lamps, manufactured by Orc Seisakusho, Co., Ltd. After a thermal treatment using a hot-air drier at 150° C. for 30 minutes, a cured coating film was obtained.

Various physical properties of the resulting cured coating films were evaluated by evaluation methods described below. The results are shown in Table 1.

<Dryness to Touch>

A sensitivity-measuring step tablet (Kodak 14-stages) was placed on the dried coating films after preliminary drying at 80° C. for 20 minutes and then subjected to a 60-second exposure process using the exposure device. Subsequently, tacking properties of the resulting cured films were evaluated upon peeling the step tablet off on the basis of the following criteria.

∘: No tacking to touch, the step tablet was facilely peeled off.

□: Little tacking to touch, the step tablet was trapped but it was peeled off.

x: Tacking to touch, the step tablet was adhered to ink and hardly peeled off.

<Sensitivity>

A sensitivity-measuring step tablet (Kodak 14-stages) was placed on the dried coating films after preliminary drying at 80° C. for 20 minutes and then was subjected to a 60-second exposure process using the exposure device. Subsequently, the exposed coating films were developed for 60 seconds with a 1% aqueous solution of sodium carbonate under a spray pressure of 2.0 kgf/mm² and then the numbers of steps of the step tablets on the remaining portions of the exposed areas was counted. The sensitivity is more excellent as the number is larger.

<Development Property>

The dried coating films after preliminary drying at 80° C. for 20 minutes were subjected to a measurement in which times to complete developments (break point) with a 1% aqueous solution of sodium carbonate under a spray pressure of 2.0 kgf/mm². The sensitivity is more excellent as the time is shorter.

<Development Controlling Range>

The dried coating films after preliminary drying at 80° C. for 20 minutes and another dried coating film dried with a 70-minute preliminary drying time period were developed with a 1% aqueous solution of sodium carbonate at a spray pressure of 2.0 kgf/mm². Then, the presence or absence of the coating film after the development was observed.

∘: After 60 seconds of development, no coating film was visually observed.

□: After 120 seconds of development, no coating film was visually observed.

x: Even after 120 seconds of development, a coating film was remained and visually observed.

<Solder Heat Resistance>

According to JIS C6481, each of the cured coating films was floated in a solder bath at 260° C. for 10 seconds three times to soak the entire surface of each of the films. The states, e.g. blistering or peeling, of the resulting films were evaluated.

∘: No change of external appearance was observed.

x: A change of external appearance was observed.

<Solvent Resistance>

The states of the cured coating films were evaluated after they had been dipped in methylene chloride (CH2CH2) for 30 minutes.

∘: No change of external appearance was observed.

□: A little change of external appearance was observed.

x: A cured coating film was peeled off.

<Pressure Cooker Test (PCT) Resistance>

The states of the cured coating films were evaluated after leaving them under a 2 atm saturated steam atmosphere at 121° C. for 100 hours.

∘: Neither swelling nor peeling was observed.

□: Swelling was observed but no peeling was observed.

x: Both swelling and peeling were observed.

| | | | | | | | | | | Comparative | | |
|---|---|---|---|---|---|---|---|---|---|---|---|---|
| | | Example | | | | | | | | Example | | |
| | | 1 | 2 | 3 | 4 | 5 | 6 | 7 | 8 | 1 | 2 | 3 |
| Dryness to touch | | ∘ | ∘ | ∘ | ∘ | ∘ | ∘ | ∘ | ∘ | x | Δ | Δ |
| Sensitivity | | 8 | 7 | 8 | 7 | 7 | 9 | 8 | 9 | 4 | 5 | 7 |
| Development | | 40 | 40 | 30 | 20 | 35 | 25 | 30 | 15 | 60 or | 50 | 60 |
| property | | | | | | | | | | more | | |
| (second) | | | | | | | | | | | | |
| Devel- | 20 min. | ∘ | ∘ | ∘ | ∘ | ∘ | ∘ | ∘ | Δ | x | ∘ | Δ |
| opment | 70 min. | ∘ | ∘ | ∘ | ∘ | ∘ | ∘ | ∘ | ∘ | x | x | x |
| control- | | | | | | | | | | | | |
| ling | | | | | | | | | | | | |
| range | | | | | | | | | | | | |

| | | | | | | | | | | | |
|---|---|---|---|---|---|---|---|---|---|---|---|
| Solder heat | ∘ | ∘ | ∘ | ∘ | ∘ | ∘ | ∘ | ∘ | ∘ | ∘ | ∘ |
| resistance | | | | | | | | | | | |
| Solvent resistance | ∘ | ∘ | ∘ | ∘ | ∘ | ∘ | ∘ | ∘ | Δ | Δ | Δ |
| PCT | ∘ | ∘ | ∘ | ∘ | ∘ | ∘ | ∘ | ∘ | Δ | ∘ | x |

Polycarboxylic acid resin compositions of the present invention show excellent tack-free property and can quickly be dissolved in an alkali while keeping their photosensitivity, and they also show good development controlling ranges and provide patterns excellent in heat resistance, electric insulation, and chemical resistance. Therefore, the polycarboxylic acid resin compositions of the present invention can suitably be used as a solder resist for a print circuit board.

### INDUSTRIAL APPLICABILITY

According to the present invention, there are provided a polycarboxylic acid resin, its composition, and its cured product. The composition can facilely be dried upon preliminary heating and the cured product shows an improved tack-free property, an excellent photo-curing property, an excellent development property in an aqueous alkali solution, and excellent physical properties such as electrical, mechanical, heat resistance, solvent resistance, adhesiveness, flexibility, etc.

1. A polycarboxylic acid resin composition comprising:
a polycarboxylic acid resin obtained by reacting one or more epoxy resin (a), having two glycidyl groups, with one or more dibasic acid (b), represented by the general formula (1) shown below having 4-10 carbon atoms, and one or more ethylenically unsaturated monocarboxylic acid (c) to obtain a linear adduct polymer (A); and by reacting the linear adduct polymer (A) with one or more polybasic acid anhydride (d), (wherein R₂′ represents an alkylene, hydroxyalkylene, alkenylene, cycloalkylene, or cycloalkenylene group having 2-8 carbon atoms),
a reactive diluent (g), and
a sealant (h).

2. A polycarboxylic acid resin composition according to claim 1, further comprising photopolymerisation initiator (i).

3. A polycarboxylic acid resin composition according to claim 1, which is cured.

4. A polycarboxylic acid resin composition according to claim 2, which is cured.

5. A cured product prepared by curing the polycarboxylic acid resin composition according to claim 1.

6. A cured product prepared by curing the polycarboxylic acid resin composition according to claim 2.
